(19) United States
(12) Patent Application Publication
(10) Pub. No.: US 2005/0155622 A1
(43) Pub. Date: Jul. 21, 2005

(54) Cleaning system and method using ultrasonic vibrations and a fluid stream

(76) Inventor: Henry J. Leis, Narberth, PA (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/758,786

(22) Filed: Jan. 16, 2004

(51) Int. Cl. B08B 3/02

(52) U.S. Cl. 134/1; 15/22.1; 15/21.1; 134/198; 134/184

(57) ABSTRACT

A preferred embodiment of a system for cleaning a surface a system for cleaning a surface includes a wand comprising a body, a neck mechanically coupled to the body, and a brush mechanically coupled to the neck and comprising a plurality of bristles for contacting the surface. The wand also includes an ultrasound generator mounted on at least one of the neck and the body so that ultrasonic vibrations generated by the ultrasound generator cause the bristles to oscillate and ultrasonic sound waves generated by the ultrasound generator are directed toward the surface. The system further includes a fitting mounted on at least one of the neck and the brush for receiving pressurized fluid and directing the pressurized fluid toward the surface.

### FIELD OF THE INVENTION

The present invention relates to a system and a method for cleaning surfaces. More particularly, the invention relates to a system and a method for cleaning a surface using ultrasonic vibrations and a stream of fluid such as water.

### BACKGROUND OF THE INVENTION

The use of cleaning devices that use ultrasonic vibrations to increase cleaning effectiveness is known. Ultrasonic vibrations alone, however, do not necessarily remove dirt and other contaminates from the surface being cleaned. Rather, some type of rinsing must usually be performed after the ultrasonic vibrations have loosened or dislodged the contaminates. The need for a separate rinsing step represents an additional step in the cleaning process, and thus adds effort and time to the cleaning process. Moreover, access to a faucet, hose, or other rinsing means is required to conduct the rinsing step. Also, ultrasonic vibrations alone may not be effective in loosening or dislodging dirt and contaminates from a heavily soiled surface.

### SUMMARY OF THE INVENTION

A preferred embodiment of a system for cleaning a surface comprises a wand comprising a body, a neck mechanically coupled to the body, and a brush mechanically coupled to the neck and comprising a plurality of bristles for contacting the surface. The wand also comprises an ultrasound generator mounted on at least one of the neck and the body so that ultrasonic vibrations generated by the ultrasound generator cause the bristles to oscillate and ultrasonic sound waves generated by the ultrasound generator are directed toward the surface.

The system also comprises a reservoir for holding a fluid, a pump in fluid communication with the reservoir, and a fitting in fluid communication with the pump and mounted on at least one of the brush and the neck so that the fitting directs a stream of the fluid toward the surface.

A preferred embodiment of a cleaning system comprises a wand comprising a body, a neck mechanically coupled to the body, a brush mechanically coupled to the neck, and an ultrasound generator mounted on at least one of the body and the neck. The system also comprises a fitting mounted on at least one of the brush and the neck, a pump in fluid communication with the fitting, and a fluid reservoir in fluid communication with the pump.

Another preferred embodiment of a system for cleaning a surface comprises a brush having a plurality of bristles, a fitting mechanically coupled to the brush for directing a stream of fluid at the surface, and an ultrasound generator for causing the bristles to oscillate.

Another preferred embodiment of a system for cleaning a surface comprises a wand comprising a body, a neck mechanically coupled to the body, and a brush mechanically coupled to the neck and comprising a plurality of bristles for contacting the surface. The wand also comprises an ultrasound generator mounted on at least one of the neck and the body so that ultrasonic vibrations generated by the ultrasound generator cause the bristles to oscillate and ultrasonic sound waves generated by the ultrasound generator are directed toward the surface. The system further comprises a fitting mounted on at least one of the neck and the brush for receiving pressurized fluid and directing the pressurized fluid toward the surface.

A preferred method for cleaning a surface using a wand having an ultrasound generator comprises positioning the wand proximate the surface so that the ultrasound generator is acoustically coupled to the surface, and directing a stream of fluid at the surface from the wand.

A preferred method for cleaning a surface comprises directing ultrasonic sound waves and a stream of fluid at the surface while scrubbing the surface with a brush.

### BRIEF DESCRIPTION OF THE DRAWINGS

The foregoing summary, as well as the following detailed description of a preferred embodiment, is better understood when read in conjunction with the appended diagrammatic drawings. For the purpose of illustrating the invention, the drawings show an embodiment that is presently preferred. The invention is not limited, however, to the specific instrumentalities disclosed in the drawings. In the drawings:

FIG. 1 is a side view of a preferred embodiment of a cleaning system;

FIG. 2 is a side view of a wand of the cleaning system shown in FIG. 1;

FIG. 3 depicts a longitudinal cross section of a body of the wand shown in FIGS. 1 and 2, and an interior of the body;

FIG. 4 is a side view of a brush and a portion of a neck of the wand shown in FIGS. 1 and 2, with the brush removed form the neck;

FIG. 5 is a bottom view of the brush shown in FIG. 4;

FIG. 6 shows a means of coupling a piezoelectric transducer of the wand shown in FIGS. 1 and 2, and an alternative embodiment of the brush shown in FIGS. 4 and 5;

FIG. 7 is a side view of an alternative embodiment of the wand shown in FIGS. 1 and 2;

FIG. 8 is a side view of an ultrasound generator of the wand shown in FIG. 7;

FIG. 9 is another side view of the ultrasound generator shown in FIG. 8, from a perspective rotated approximately ninety degrees from the perspective of FIG. 8;

FIG. 10 is a side view of an alternative embodiment of an ultrasound generator of the wand shown in FIGS. 1 and 2;

FIG. 11 is a top view of the ultrasound generator shown in FIG. 10;

FIG. 12 is a side view of a portion of the wand shown in FIGS. 1 and 2, equipped with an optional second reservoir

FIG. 13 is a side view of an alternative embodiment of the wand shown in FIGS. 1 and 2.

### DESCRIPTION OF PREFERRED EMBODIMENTS

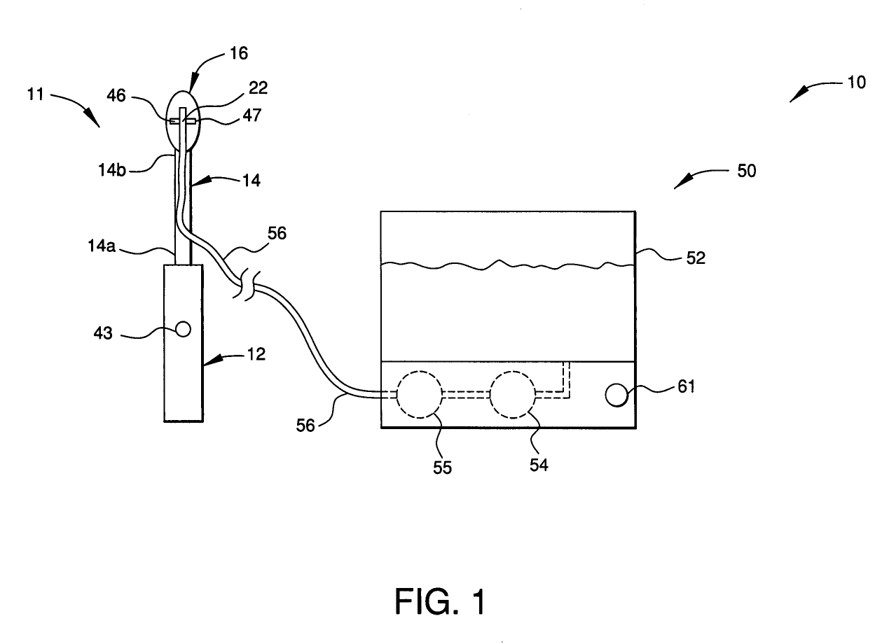

FIGS. 1 to 5 depict a preferred embodiment of a cleaning system 10. The cleaning system 10 comprises a wand 11 having body 12, a neck 14, and a brush 16 (see FIG. 1). The cleaning system 10, as explained in detail below, can clean and disinfect a surface using a combination of a ultrasonic vibrations and a stream of fluid. The cleaning system 10, or alternative embodiments thereof, can be used to clean and disinfect, for example, human or animal tissue such as skin, gums, teeth, or fingernails; floors; industrial equipment; vehicles such as automobile, aircraft, or boats; etc.

A first end 14a of the neck 14 can be secured to the body 12 by appropriate means such as screws or fasteners (the neck 14 and the body 12 can be integrally formed in alternative embodiments). The brush 16 is mounted on a second end 14b of the neck 14.

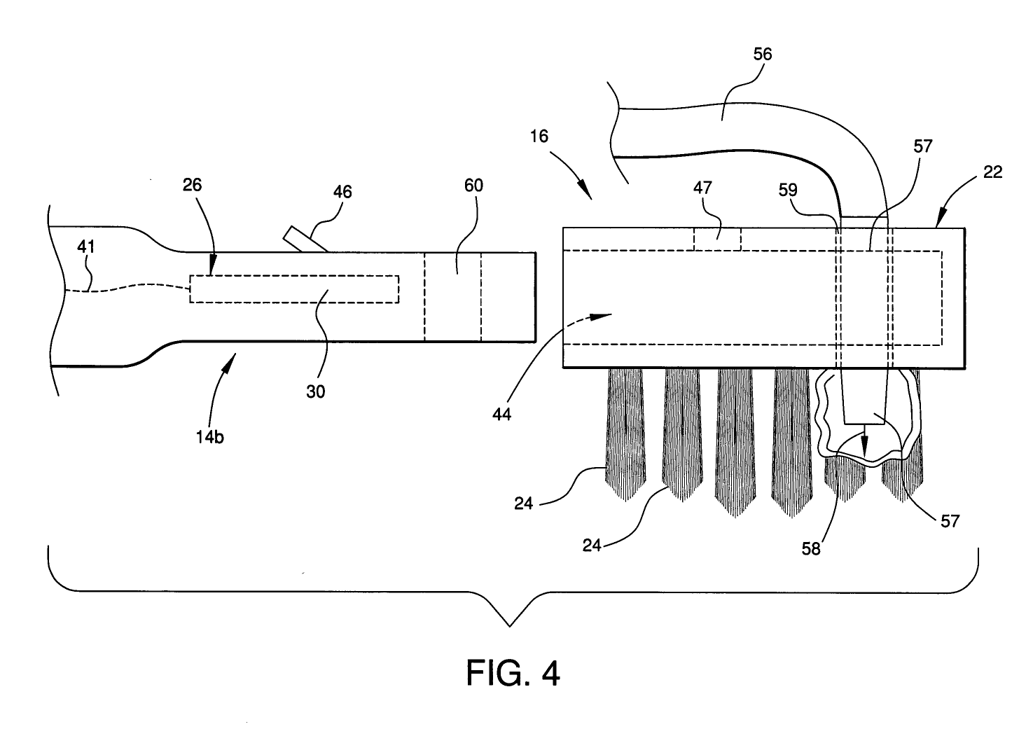

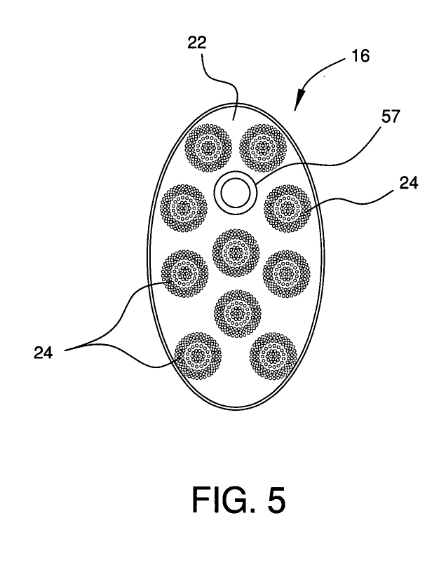

The brush 16 comprises a base 22 and a plurality of bristles 24 (see FIGS. 4 and 5). The base 22 is mounted on the second end 14b of the neck 14, as discussed below. The bristles 24 can be secured in the base 22 by a suitable means such as metal inserts (not shown). Each metal insert and a predetermined number of the bristles 24 can be inserted in a corresponding slot formed in the base 22, so that the metal insert lodges the bristles in the slot.

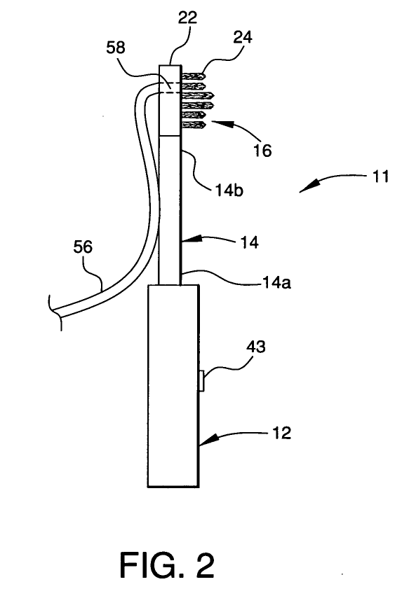

The bristles 24 can be arranged in a substantially elliptical pattern (the base 22 is preferably shaped as an ellipse to accommodate the elliptical pattern of the bristles 24). The height of the individual bristles 24 can increase toward the center of the base 22, as shown in FIG. 2). A particular arrangement for the bristles 24 is presented for exemplary purposes only; other arrangements can be used in alternative embodiments.

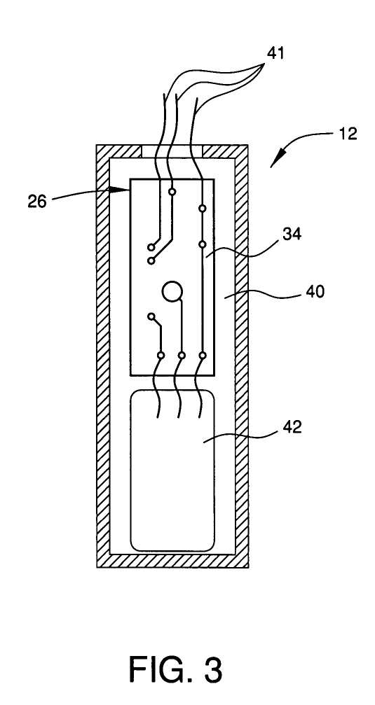

The wand 11 also includes an ultrasound generator 26 (see FIGS. 3 and 4). The ultrasound generator 26, as explained below, converts electrical energy into ultrasonic vibrations. The ultrasonic vibrations cause the bristles 24 of the brush 16 to move. The ultrasonic vibrations are also believed to disinfect the surface being cleaned by the system 10. The term “ultrasonic vibrations,” as used throughout the specification and claims, refers to mechanical vibrations within a range of approximately 1,000 Hz to approximately 1.6 MHz.

The ultrasound generator 26 can comprise, for example, a conventional piezoelectric transducer 30 and electronic driving module 34 (see FIGS. 3 and 4). The piezoelectric transducer 30 can be a piezoelectric ceramic plate (other types of piezoelectric transducers, e.g., piezoelectric crystals, can be used in alternative embodiments). The piezoelectric transducer 30 is embedded within the second end 14b of the neck 14. For example, the second end 14b neck 14 can be molded around the piezoelectric transducer 30.

The electronic driving module 34 is located within a cavity 40 formed in the body 12 (the electronic driving module 34 can be located within the neck 14 in alternative embodiments). The electronic driving module 34 is electrically coupled to the piezoelectric transducer 30 by wires 41 that extend through the body 12 and the neck 14.

Power for the electronic driving module 34 can be supplied by a rechargeable battery 42 located in the cavity 40. The electronic driving module 34 can be activated and deactivated by a suitable on-off switch 43 located on the body 12. The wand 11 can be configured for use with a conventional recharging base (not shown) to recharge the battery 42 during periods of non-use.

The electronic driving module 34 can be powered by other means in alternative embodiments. For example, power can be provided by an external battery pack. Power can also be provided by conventional 120V, 60 Hz wall outlet and a suitable transformer located within or external to the body 12.

The electronic driving module 34 converts electrical energy provided by the battery 42 into a current having an appropriate oscillatory frequency and voltage level. The piezoelectric transducer 30 expands and contracts volumetrically in response to the output current of the electronic driving module 34. This expansion and contraction causes the piezoelectric transducer 30 to vibrate.

The brush 16 is mounted on the second end 14b of the neck 14, as noted above. The base 22 of the brush 16 can have a cavity 44 formed therein (see FIG. 4). The second end 14b of the neck 14 is sized to fit snugly, i.e., with minimal clearance, within with cavity 44. A clip 46 can be formed on the second end 14b of the neck 14. The clip 46 can engage the brush 16 by way of a slot 47 formed in the base 22, thereby securing the brush 16 to the neck 14.

The brush 16 is responsive to the vibrations produced by the ultrasound generator 26. In particular, the vibration of the piezoelectric element 30 is believed to cause the surrounding portion of the second end 14a of the neck 14 to vibrate. The vibration of the second end 14b, in turn, causes the base 22 of the brush 16 to vibrate. The vibration of the base 22 imparts a high-speed oscillating motion in the bristles 24. The amplitude and frequency of the oscillating motion is dependent upon factors such as the stiffness and length of the bristles 24, the dimensions of the base 22, etc. Moreover, the optimal values for these parameters is application dependent. Hence, specific values for the amplitude and frequency of the oscillating motion are not specified herein.

The vibration of the piezoelectric device 30 is believed to generate ultrasonic sound waves. The ultrasonic sound waves, it is believed, can help to disinfect the surface being cleaned.

The bristles 24 should be formed from a material having a stiffness sufficient to transmit the oscillating motion induced by the piezoelectric element 30 to the surface being cleaned. The bristles 24 should be soft enough, however, to avoid irritating or otherwise adversely affecting the surface being cleaned. For example, bristles 24 formed from a material such as Dupont Nylon® can be used when the cleaning system 10 is used for cleaning sensitive surfaces such as the surface of human skin or gums. Bristles 24 formed from a stiffer material can be used when the cleaning system is used to clean relatively hard surfaces such as the surface of a sink or countertop.

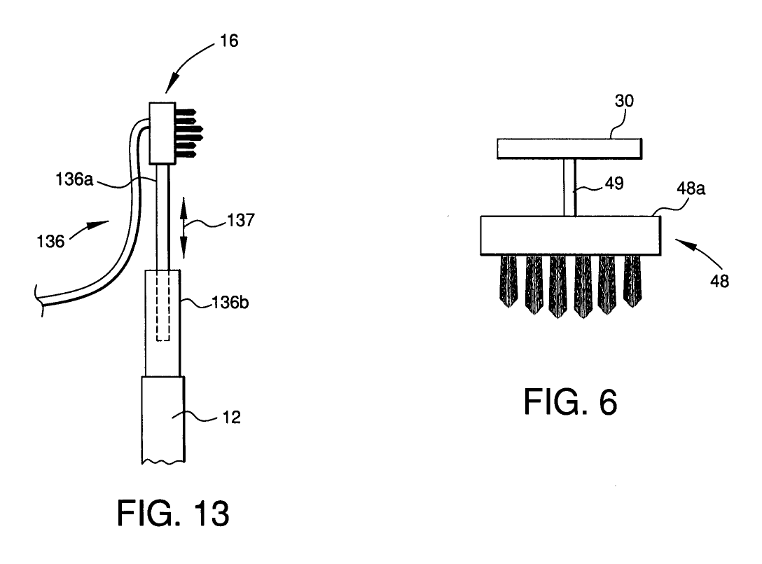

The piezoelectric transducer 30 can be operably coupled to the brush 16 by other means in alternative embodiments. For example, FIG. 6 depicts an alternative embodiment in which the piezoelectric transducer 30 is mechanically coupled to a base 48a of a brush 48 by way of an elongated rigid member 49.

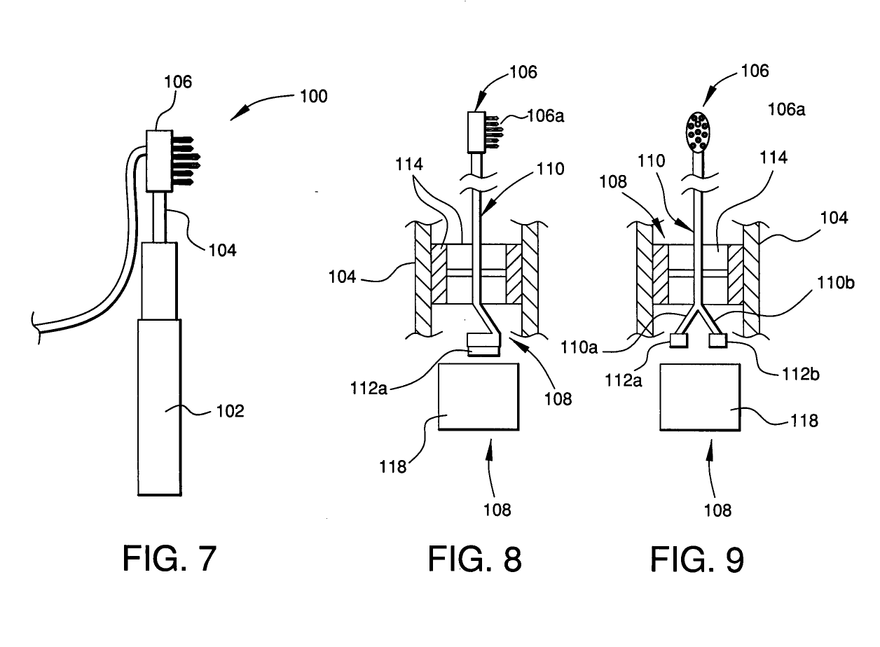

Moreover, the ultrasonic vibrations can be generated by a suitable means other than a piezoelectric device in alternative embodiments. For example, FIGS. 7 to 9 depict a wand 100 comprising a body 102, a neck 104, a brush 106, and an ultrasound generator 108. The ultrasound generator 108 comprises an elongated rigid member 110. The rigid member 110 has a first leg 110a and a second leg 110b disposed at a first end thereof. The ultrasound generator 108 further includes a first and a second permanent magnet 112a, 112b secured to the respective first and second legs 110a, 110b.

The rigid member 110 extends through an interior of the neck 104. The rigid member is supported by a sleeve 114 fixedly coupled to an inner surface of the neck 104. The brush 106 is mounted on a second end of the rigid member 110.

The body 102 includes a magnetic field generator 118 capable of generating an oscillating magnetic field. The neck 104 is mounted on the body 102 so that the first and second magnets 112a, 112b are positioned within the oscillating magnetic field. The oscillation of the magnetic field causes an oscillating motion in the magnets 112a, 112b. The oscillating motion of the magnets 112a, 112b, in turn, causes the rigid member 110 (and the attached brush 106) to vibrate.

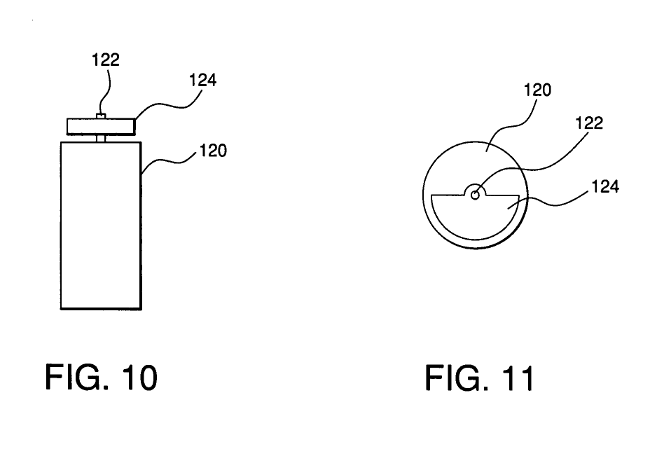

An eccentrically-weighted motor can be used as the ultrasound generator in other alternative embodiments (see FIGS. 10 and 11). In particular, an electrical motor 120 having a rotating shaft 122 can be installed within the body 12 or the neck 14 of alternative embodiments of the wand 11. A weight 124 is secured to the shaft 122 so that the weight 124 is asymmetrically disposed around an axis of rotation of the shaft 122. The weight 124 acts as an unbalanced load on the motor 120 when the weight 124 is rotated by the shaft 122. The motor 120 can be positioned within, and secured to secured to the body 12 or the neck 14 so that the vibrations produced by the motor 120 are transmitted to the brush 16 by way of the neck 14.

The cleaning system 10 also comprises a device 50 for generating a stream of fluid (see FIG. 1). The device 50 comprises a fluid reservoir 52, and a conventional electrically-powered pump 54 in fluid communication with the fluid reservoir 52. The pump 54 is preferably of the self-priming type. The device 50 preferably includes a pulsing valve 55 of conventional design. The pulsing valve 55 is in fluid communication with the pump 54. A length of flexible tubing 56 attached to the pulsing valve 55.

The pump 54 is supplied with fluid, e.g., water, from the reservoir 52. The pump 54 pressurizes the fluid, and pumps the fluid through the tubing 56 by way of the pulsing valve 55. Power for the pump 54 can be supplied by a rechargeable battery (not shown), 120V, 60 Hz current from a conventional wall outlet, or other suitable sources. The pump 54 can be activated and deactivated by a suitable on-off switch 61. Alternatively, the pump 54 can be electrically coupled to the on-off switch 43 on the wand 11, thereby permitting the pump 54 and the ultrasound generator 26 to be activated simultaneously using a single switch.

A fitting is mounted on the brush 20 for coupling the tubing 56 to the brush 20. The fitting is preferably a nozzle 57 (see FIGS. 4 and 5). The nozzle 57 extends through the base 22 and the second end 14b of the neck 14 by way of respective through holes 59, 60 formed therein (the diameter of the through hole 59 is exaggerated in FIG. 4, for clarity).

An end of the tubing 56 is attached to the nozzle 57 so that the nozzle 57 is supplied with pressurized fluid from the pump 54. (The tubing 56 is depicted in the figures as being routed along the exterior of the neck 14. The tubing 56 can be routed internal to the neck 14 in alternative embodiments.)

The nozzle 57 directs the pressurized fluid between the bristles 24 and toward the surface being cleaned. The nozzle 57 preferably has a converging geometry, i.e., the entrance diameter of the nozzle 57 is greater than the exit diameter, so that the nozzle 57 accelerates the pressurized fluid (see FIG. 4). The nozzle 57 thus discharges a pulsing jet of fluid toward the surface being cleaned (the fluid jet pulses due to the effect of the pulsing valve 55; the fluid jet is denoted in FIG. 4 as an arrow 58). The fluid jet 58, as discussed below, acts in conjunction with the oscillating motion of the bristles 24 and the ultrasonic waves produced by the ultrasound generator 26 to loosen and wash away dirt or other contaminates from the surface being cleaned.

Alternative embodiments of the cleaning system 10 can include two or more of the nozzles 57 interspersed throughout the length and width of the brush 16. Moreover, the use of the nozzle 57 has been described for exemplary purposes only. Any suitable fitting that couples the tubing 56 to the brush 20 so that the fluid from the tubing 56 is directed toward the surface being cleaned can be used in lieu of the nozzle 57.

The optimal velocity, shape, and, flow-rate of the fluid jet 58 are application dependent. Specific values for these parameters therefore are not specified herein. Moreover, alternative embodiments of the device 50 can be equipped with a variable-speed pump or other provisions to vary the velocity or flow-rate of the fluid jet 58.

A user can operate the cleaning system 10 by holding the wand 11 and bringing the bristles 24 of the brush 16 into contact with the surface to be cleaned. (The body 12 of the wand 11 preferably includes grips or other provisions formed from a suitable non-slip material to minimize the potential for the wand 11 to slip from the user's hand).

Bringing the bristles 24 of the brush 16 into contact with the surface to be cleaned causes the pulsing fluid jet 58 from the nozzle 57 to impinge upon the surface. The impingement of the fluid jet 58 on the surface can help to loosen or dislodge dirt and other contaminates on the surface. In addition, the oscillating motion of the bristles 24 is also believed to loosen or dislodge the dirt and contaminates. The fluid jet 58 helps to rinse the dirt and contaminates from the surface once the dirt and contaminates have been loosened.

Bringing the wand 11 in proximity to the surface to be cleaned also causes the ultrasonic sound waves to impinge upon the surface. The ultrasonic sound waves, it is believed, can help to loosen or dislodge dirt and contaminates on the surface. Moreover, it is believed that the ultrasonic vibrations can weaken or rupture the cell wall of bacteria, weakening or killing the bacteria. The cleaning system 10 can thus disinfect, as well as clean the surface.

The cleaning system 10 can be used to clean dirt and other contaminates from a surface, and to disinfect the surface on a substantially simultaneous basis. Hence, the need to expend additional effort and time to disinfect the surface after cleaning can be eliminated through the use of the cleaning system 10.

Moreover, it is believed that the use of a pulsing fluid stream such as the fluid jet 58 makes the cleaning effectiveness of the cleaning system 10 greater than that of a conventional ultrasonic cleaning device. In particular, the effect of the fluid jet 58 impinging on the surface, in conjunction with the scrubbing action of the brush 16 and the ultrasonic sound waves, is believed to particularly effective at loosening and dislodging dirt and other contaminate from the surface.

In addition, the fluid jet 58 immediately washes the dirt and contaminates from the surface once the dirt and contaminates have been loosened, further enhancing the cleaning effectiveness of the cleaning system 10. Also, the use of a fluid stream such as the fluid jet 58 obviates the need to rinse the surface after the dirt or other contaminates have been loosened or dislodged. Hence, the use of the cleaning system 10 can eliminate need to expend additional time and effort to rinse the surface.

The wand 11 is approximately ten inches long, and has a maximum diameter of approximately one and one-half inches. These particular dimensions are believed to be well suited for applications such as cleaning and disinfecting teeth, gums, fingernails, etc. The dimensions of the wand 11 can altered to optimize the wand 11 for other applications. For example, the dimensions of the wand 11 can be increased so that the wand 11 is suitable for use in the shower or bath to clean and disinfect human skin. The dimensions of the wand 11 can be increased still further for applications such as cleaning and disinfecting floors, industrial equipment, etc.

The fluid reservoir 52 of the device 50 can be filled with a fluid other than water to enhance the effectiveness of the cleaning system 10. For example, the fluid reservoir 52 can be filled with a cleaning solution or cleaning solvent suitable for the particular application in which the cleaning system 10 is to be used.

Alternative embodiments of the cleaning system 10 can be constructed without the fluid reservoir 52 and the pump 54. For example, the tubing 56 can be coupled directly to a source of pressurized fluid, e.g., a faucet, in alternative embodiments.

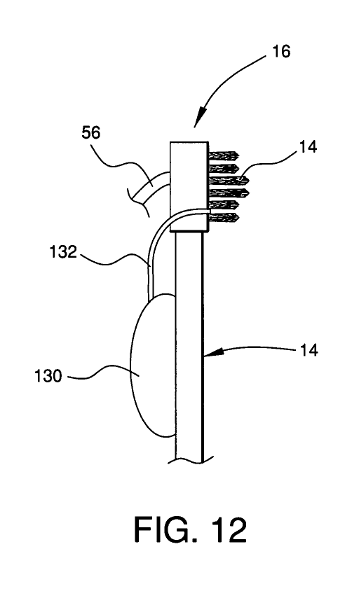

Moreover, the wand 11 can include an additional reservoir 130, as shown in FIG. 12. The reservoir 130 can be used to hold soap or other cleaning fluids. The reservoir 130 can be attached to tubing 132. The tubing 132 can be routed and attached to the brush 16. The reservoir 130 can be formed from a resilient material that permits the reservoir 130 to be compressed (squeezed) so that the soap is pumped through the tubing 132 and to the surface being cleaned. Other alternative embodiments can be equipped with a powered pump for transferring the soap from the reservoir 130 to the brush 16.

The cleaning system 10 can be supplied with multiple brushes suited for different applications. For example, the multiple brushes can have different sizes, and different one of the brushes can be equipped with bristles of varying stiffness. A particular brush having a size and stiffness suitable for a particular application can thus be chosen and mounted on the wand 11 by the user.

Alternative embodiments of the wand 11 can be equipped with a telescoping neck. For example, FIG. 13 depicts a telescoping neck 136 that can be used in conjunction wit the body 12 and the brush 16. The first portion 136a can move in relation to the second portion 136b, in the directions denoted by the arrow 137. This feature can allow the length of the neck 136 to be adjusted to suit a particular application. Moreover, the telescoping neck 136 can facilitate storage of the wand 11 in a smaller space than would otherwise be possible.

The wand 11 can be mounted in a fixed manner in certain applications. For example, the wand 11 can be mounted above a sink used for surgical scrubbing or pet grooming. This arrangement permits the fluid discharged by the nozzle 57 to drain directly into the sink, and frees the user from the need to hold the wand 11.

Larger embodiments of the cleaning system 10 can be used in industrial applications. For example, an enlarged version of the wand 11 can used in a commercial car wash. In particular, the enlarged version of the wand 11 can be mounted in a stationary manner, so that the wand contacts and cleans an automobile passing through the car wash. (The enlarged version of the wand 11 and an enlarged version of device 50 for generating a fluid stream can optionally be integrated as a unitary structure in this type of application). Alternatively, an enlarged version of the wand 11 can be used in a hand-held manner to wash an automobile, or other objects such as aircraft, boats, floors large countertops, etc.

The amplitude of the oscillatory motion of the bristles 24 can be increased, if desired, through the use of an eccentrically-weighted motor such as the motor 120 in conjunction with the piezoelectric transducer 30. For example, the motor 120 and the attached weights 124 can be configured to generate vibrations having a relatively high amplitude and low frequency in comparison to the vibrations generated by the piezoelectric transducer 30. The high amplitude, low frequency vibrations, it is believed, can enhance the cleaning effectiveness of the brush 16. The ultrasonic sound waves produced by the piezoelectric transducer 30 can disinfect, and loosen and dislodge dirt and contaminates as discussed above.

The foregoing description is provided for the purpose of explanation and is not to be construed as limiting the invention. While the invention has been described with reference to preferred embodiments or preferred methods, it is understood that the words which have been used herein are words of description and illustration, rather than words of limitation. Furthermore, although the invention has been described herein with reference to particular structure, methods, and embodiments, the invention is not intended to be limited to the particulars disclosed herein, as the invention extends to all structures, methods and uses that are within the scope of the appended claims. Those skilled in the relevant art, having the benefit of the teachings of this specification, may effect numerous modifications to the invention as described herein, and changes may be made without departing from the scope and spirit of the invention as defined by the appended claims.

### Parts List

Cleaning system 10
Wand 11
Body 12
Neck 14
First end 14a
Second end 14b
Brush 16
Base 22
Bristles 24
Ultrasound generator 26
Piezoelectric transducer 30
Electronic driving module 34
Cavity 40 (in body 12)
Wires 41 (between piezoelectric transducer 30 and electronic driving module 34)
Battery 42
On-off switch 43
Cavity 44 (in brush 16)
Clip 46 (on neck 14)
Slot 47 (on base 22)
Brush 48
Rigid member 49
Device 50 for generating a fluid stream
Fluid reservoir 52
Pump 54
Pulsing valve 55
Tubing 56
Nozzle 57
Fluid jet 58
Through hole 59 (in base 22)
Through hole 60 (in neck 14)
On-off switch 61
Wand 100
Body 102
Neck 104
Brush 106
Ultrasound generator 108
Rigid member 110
First leg 110a
Second leg 110b
First permanent magnet 112a
Second permanent magnet 112b
Sleeve 114
Magnetic field generator 118
Eccentrically-weighted motor 120
Shaft 122 (of motor 120)
Weight 124
Reservoir 130
Tubing 132
Telescoping neck 136
First portion 136a
Second portion 136b
Arrow 137

1. A system for cleaning a surface, comprising:
a wand comprising a body, a neck mechanically coupled to the body, a brush mechanically coupled to the neck and comprising a plurality of bristles for contacting the surface, and an ultrasound generator mounted on at least one of the neck and the body so that ultrasonic vibrations generated by the ultrasound generator cause the bristles to oscillate and ultrasonic sound waves generated by the ultrasound generator are directed toward the surface;
a reservoir for holding a fluid;
a pump in fluid communication with the reservoir; and
a fitting in fluid communication with the pump and mounted on at least one of the brush and the neck so that the fitting directs a stream of the fluid toward the surface.

2. The system of claim 1, wherein the fitting comprises a nozzle.

3. The system of claim 2, wherein an entrance diameter of the nozzle is greater than an exit diameter of the nozzle.

4. The system of claim 1, wherein the fitting directs the stream of fluid between the bristles.

5. The system of claim 1, wherein the ultrasound generator comprises a piezoelectric transducer.

6. The system of claim 5, wherein the ultrasound generator further comprises an electronic driving module electrically coupled to the ultrasound generator.

7. The system of claim 5, wherein the piezoelectric transducer is a piezoelectric crystal.

8. The system of claim 1, wherein the ultrasound generator comprises an elongated member mechanically coupled to the brush, a magnet mechanically coupled to the elongated member, and a magnetic field generator, the magnet being positioned proximate the magnetic field generator so that the magnetic field generator causes the magnet to oscillate.

9. The system of claim 8, wherein the magnetic field generator is mounted within the body and the elongated member extends through the neck.

10. The system of claim 1, wherein the ultrasound generator comprises an eccentrically-weighted motor.

11. The system of claim 1, further comprising a pulsing valve in fluid communication with the pump.

12. The system of claim 1, wherein the neck is a telescoping neck.

13. Further comprising a second reservoir mounted on the wand for directing a second fluid toward the surface.

14. The system of claim 1, wherein the brush further comprises a base having a cavity formed therein for receiving an end of the neck.

15. The system of claim 14, wherein at least a portion of the fitting is positioned in through holes formed in the end of the neck and the base.

16. The system of claim 14, wherein the ultrasound generator comprises a piezoelectric transducer mounted in the end of the neck so that vibrations generated by the ultrasound generator are transmitted to the bristles by way of the end of the neck and the base.

17. The system of claim 1, wherein the brush further comprises a base, the bristles are mounted on the base, and the fitting is mounted on and extends through the base.

18. The system of claim 5, wherein the piezoelectric transducer is mechanically coupled to the brush by an elongated rigid member.

19. The system of claim 5, wherein the ultrasound generator further comprises an eccentrically-weighted motor.

20. A cleaning system, comprising:
a wand comprising a body, a neck mechanically coupled to the body, a brush mechanically coupled to the neck, and an ultrasound generator mounted on at least one of the body and the neck;
a fitting mounted on at least one of the brush and the neck;
a pump in fluid communication with the fitting; and
a fluid reservoir in fluid communication with the pump.

21. The system of claim 20, wherein the brush is mounted on the neck.

22. The system of claim 20, wherein the fitting comprises a nozzle.

23. The system of claim 20, wherein the ultrasound generator comprises a piezoelectric transducer.

24. The system of claim 20, further comprising a pulsing valve in fluid communication with the pump.

25. A system for cleaning a surface, comprising a brush having a plurality of bristles, a fitting mechanically coupled to the brush for directing a stream of fluid at the surface, and an ultrasound generator for causing the bristles to oscillate.

26. The system of claim 25, further comprising a wand comprising a body, and a neck mechanically coupled to the body and the brush, the ultrasound generator being mounted on a least one of the body and the neck.

27. The system of claim 25, wherein the fitting comprises a nozzle.

28. The system of claim 27, wherein an entrance diameter of the nozzle is greater than an exit diameter of the nozzle.

29. The system of claim 25, wherein the ultrasound generator comprises a piezoelectric transducer.

30. The system of claim 29, wherein the ultrasound generator further comprises an electronic driving module electrically coupled to the ultrasound generator.

31. The system of claim 29, wherein the piezoelectric transducer is a piezoelectric crystal.

32. The system of claim 25, wherein the ultrasound generator comprises an elongated member mechanically coupled to the brush, a magnet mechanically coupled to the elongated member, and a magnetic field generator, the magnet being positioned proximate the magnetic field generator so that the magnetic field generator causes the magnet to oscillate.

33. The system of claim 25, wherein the ultrasound generator comprises an eccentrically-weighted motor.

34. A system for cleaning a surface, comprising:
a wand comprising a body, a neck mechanically coupled to the body, a brush mechanically coupled to the neck and comprising a plurality of bristles for contacting the surface, and an ultrasound generator mounted on at least one of the neck and the body so that ultrasonic vibrations generated by the ultrasound generator cause the bristles to oscillate and ultrasonic sound waves generated by the ultrasound generator are directed toward the surface; and
a fitting mounted on at least one of the neck and the brush for receiving pressurized fluid and directing the pressurized fluid toward the surface.

35. A method for cleaning a surface using a wand having an ultrasound generator, comprising:
positioning the wand proximate the surface so that the ultrasound generator is acoustically coupled to the surface; and
directing a stream of fluid at the surface from the wand.

36. The method of claim 35, further comprising positioning the wand proximate the surface so that bristles of a brush of the wand scrub the surface in response to ultrasonic vibrations generated by the ultrasound generator.

37. The method of claim 35, wherein directing a stream of fluid at the surface from the wand comprises directing a jet of the fluid at the surface from the wand.

38. The method of claim 35, wherein directing a stream of fluid at the surface from the wand comprises directing a pulsing stream of the fluid at the surface from the wand.

39. The method of claim 35, wherein directing a stream of fluid at the surface from the wand comprises directing one of a stream of water, a stream of cleaning solution, and a stream of solvent at the surface from the wand.

40. The method of claim 35, wherein positioning the wand proximate the surface so that the ultrasound generator is acoustically coupled to the surface comprises positioning the wand proximate the surface so that ultrasonic sound waves generated by the ultrasound generator are directed at the surface.

41. A method for cleaning a surface, comprising directing ultrasonic sound waves and a stream of fluid at the surface while scrubbing the surface with a brush.

42. The method of claim 41, wherein scrubbing the surface with a brush comprises causing bristles of the brush to oscillate in response to ultrasonic vibrations and bringing the bristles into contact with the surface.

43. The method of claim 41, wherein directing ultrasonic sound waves and a stream of fluid at the surface comprises directing a jet of the fluid at the surface.

44. The method of claim 41, wherein directing ultrasonic sound waves and a stream of fluid at the surface comprises directing a pulsing stream of the fluid at the surface.

45. The method of claim 41, wherein directing ultrasonic sound waves and a stream of fluid at the surface comprises directing one of a stream of water, a stream of cleaning solution, and a stream of solvent at the surface.
